(19) United States
(12) Patent Application Publication
(10) Pub. No.: US 2008/0217395 A1
(43) Pub. Date: Sep. 11, 2008

(54) Secure Internet Payment Apparatus and Method

(76) Inventors: Robert S. Jenkins, Chesterfield, MO (US); Brian S. Cross, St. Louis, MO (US)

Correspondence Address: SENNIGER POWERS LLP, ONE METROPOLITAN SQUARE, 16TH FLOOR, ST LOUIS, MO, 63102, US

(21) Appl. No.: 11/552,209

(22) Filed: Oct. 24, 2006

Related U.S. Application Data
(63) Continuation-in-part of application No. 11/256,750, filed on Oct. 24, 2005.

(51) Int. Cl. G07F 19/00

(52) U.S. Cl. 235/379

(57) ABSTRACT

An improved apparatus and method for making payment over the internet with a financial media, such as a financial card, RFID, contactless media or the like, are disclosed. The apparatus includes an online enabled device or circuit connected to the internet to receive a communication indicating an amount due for the transaction. A reader reads data from the financial media. The data includes an account number corresponding to the financial media. The circuit transmits the data and the amount due to a financial institution corresponding to the financial media and allows the financial institution to provide an authorization number to the merchant indicating that the transaction has been approved. The merchant does not obtain access to the account number data. A method for a customer to pay for a transaction over an internet connection is also disclosed. Other apparatus and methods are also disclosed.

This application is a continuation-in-part of U.S. Non-provisional patent application Ser. No. 11/256,750, filed Oct. 24, 2005, the entire contents of which are hereby incorporated herein by reference.

### BACKGROUND OF THE INVENTION

The fraudulent use of financial information (typically a debit card, credit card, stored value card, account number, or related financial media or data) is a major problem today. This can be a particular problem for internet transactions where the customer is not required to physically present the financial media as part of the purchase procedure. Rather, a customer often inputs the account number and expiration date without ever proving possession of the financial media.

There is also risk for the customer who may have no personal knowledge of the merchant or of the merchant's business practices for keeping financial information confidential. An unscrupulous merchant could use the customer's financial information to make unauthorized purchases. Even when a merchant is completely trustworthy, computer hackers can break into the merchant's computer records and obtain stored financial information from unsuspecting customers, perhaps months or even years after the underlying purchase was made.

Websites today often provide encryption techniques which protect the transmission of financial data over the internet. Such techniques, however, do not require the customer to prove possession of the financial media during the purchase transaction. Such techniques may also allow the merchant to learn the customer's financial account number and other important financial data. Even when such techniques prevent the merchant from reading encrypted financial data, the data is still provided to the merchant on site and can be stored by the merchant. This may present a security risk.

A secure internet payment apparatus and method of the present invention are disclosed.

### SUMMARY OF THE INVENTION

Among the objects of the present invention are to provide an improved apparatus and method for making secure purchases using the internet, to provide an improved apparatus and method which require the customer to prove possession of the financial media during the purchase transaction, to provide an improved apparatus and method which do not require the customer to provide the merchant with the purchaser's account number data, and to provide an improved apparatus and method which are convenient for the customer to use.

In one embodiment, the invention comprises an apparatus for enabling a retail customer to make a payment for a purchase from a third party using a financial card through an internet connection. The purchase is charged against an account held by the retail customer with a financial institution. The apparatus includes a magnetic card reader located in the retail customer's home, office or personal space for enabling the retail customer to swipe the financial card through the magnetic card reader. The magnetic card reader is adapted to read customer information upon the occurrence of the card being swiped. The apparatus includes a circuit coupled to the magnetic card reader and the internet connection for transmitting the customer information to the financial institution over the internet. Data corresponding to the third party and a monetary amount corresponding to the purchase are also transmitted to the financial institution over the internet. The monetary amount corresponding to the purchase may be charged against the account.

In another embodiment, the invention comprises a method for a customer to pay for a transaction over an internet connection. The method includes selecting a good or service from a merchant through the internet connection and receiving a communication from the merchant indicating an amount due for the transaction. Data is read from a financial media with a reader. The data includes an account number corresponding to the financial media. The data and amount due are transmitted to a financial institution corresponding to the financial media. The financial institution is allowed to provide an authorization number to the merchant indicating that the transaction has been approved. The merchant does not obtain access to the account number.

In yet another embodiment, the invention comprises an apparatus for making a payment to a merchant for a transaction over an internet connection. The apparatus includes an online enabled device connected to the internet for receiving a communication from the merchant indicating an amount due for the transaction. A reader reads data from a financial media. The data includes an account number corresponding to the financial media. The online enabled device transmits the data and the amount due to a financial institution corresponding to the financial media and allows the financial institution to provide an authorization number to the merchant indicating that the transaction has been approved. The merchant does not obtain access to the account number data.

Other objects and features will be in part apparent and in part pointed out hereinafter.

### BRIEF DESCRIPTION OF THE DRAWINGS

FIG. 1 shows an embodiment of the present invention where a customer makes a payment to a third party with a financial media where the account number associated with the financial media does not need to be communicated to the merchant.

FIG. 2 shows another embodiment of the present invention where a customer makes a payment with a financial media where the account number associated with the financial media does not need to be communicated to the merchant.

Corresponding reference characters indicate corresponding structures and steps throughout the several views of the drawings.

### DETAILED DESCRIPTION OF PREFERRED EMBODIMENTS

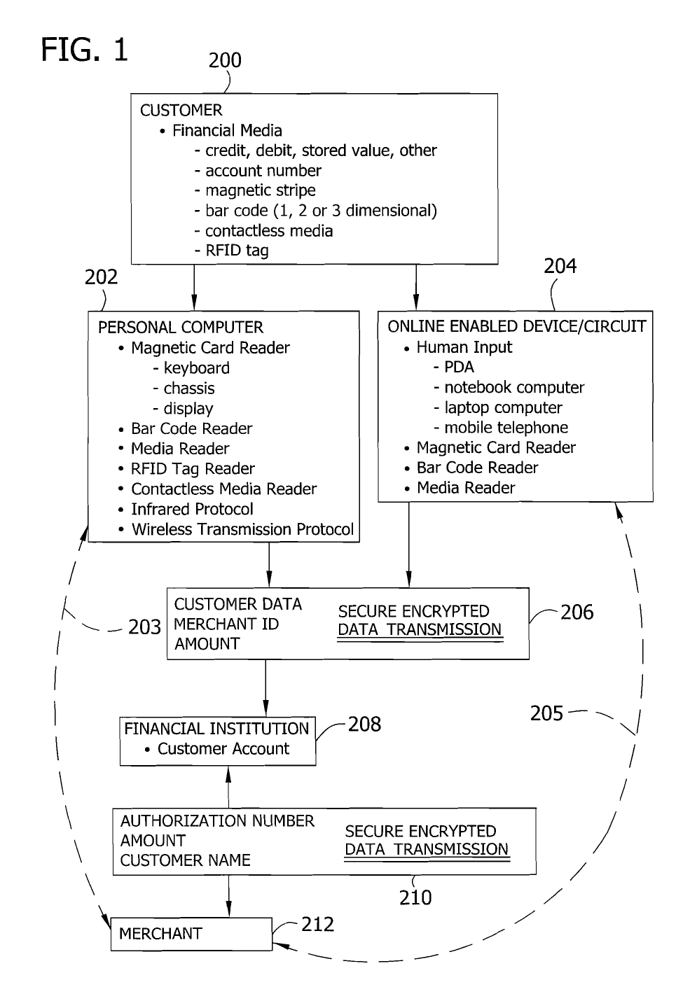

FIG. 1 shows an example of hardware which allows a customer to make a secure payment for a purchase using a financial media through an internet connection. As shown in box 200, the financial media can be a conventional credit card, debit card, stored value or other card having a magnetic strip on the back. The financial media can also have a bar code (such as the commonly found one, two and/or three dimensional bar codes commonly found on financial cards). Such media typically have a card number identifying the customer's account against which the purchase will be charged. Alternatively, the financial media in customer box 200 may be a radio frequency identification tag (“RFID tag”) or any of the known contactless financial media which can be read quickly without physical contact between the media and the reader. Examples of such contactless media include the quick pay media where the media may be affixed to a key chain for easy access and is read by simply waving the media past the reader.

Box 202 shows a conventional personal computer which includes a conventional magnetic card reader, bar code reader, RFID tag reader, contactless media reader or any other reader suitable for reading data from the financial media. Other types of readers may use an infrared protocol or a wireless transmission protocol for providing communication of the data from the financial media to the reader. The reader of whatever type may be physically attached to the keyboard, chassis or display monitor of the personal computer, although such physical attachment is not required.

When the customer wishes to select a good or service from a merchant over the internet, the customer communicates with the merchant as shown by dashed line 203 to make the selection. The merchant communicates back to indicate an amount due for the selected good or service. Alternatively, the merchant's website may communicate the amount due by simply displaying prices associated with various goods and services available for selection.

When the customer wishes to make a payment over the internet to a merchant shown in box 212, the customer swipes the card through the magnetic card reader, reads the bar code with the bar code reader or otherwise reads the media with the corresponding media reader. Such reading of the data shows that the customer has physical possession of the financial media in box 200 and does not simply know the account number corresponding to such financial media. The personal computer is programmed to receive the data, including the account number data, from the magnetic card reader, bar code reader or other media reader. The personal computer then passes that account data (which identifies the customer responsible for the account) as well as the amount of the transaction and the identity of the merchant over the internet in box 206 to the financial institution 208 responsible for the financial media in box 200. This data transmission shown by box 206 is preferably a secure, encrypted data transmission using security techniques known to those skilled in the art. Through this data transmission, the customer allows the financial institution to provide an authorization number to the merchant indicating that the transaction has been approved.

At box 208, the financial institution checks to make certain the customer's account has sufficient funds or a sufficient credit line before authorizing the transaction and charging the amount of the transaction against the customer's account. Once approved, the financial institution passes an authorization number for the transaction, the monetary amount approved, and the identity of the customer over the internet in box 210 to the merchant (or the merchant's bank) in box 212. The merchant thus receives the appropriate monetary amount for the transaction with the security of an authorization number but without ever knowing the customer's account number or media number (if different). This data transmission shown by box 210 is preferably a secure, encrypted data transmission using security techniques known to those skilled in the art.

The customer thus allows the financial institution to provide the authorization number to the merchant indicating to the merchant that the transaction has been approved. In addition or in the alternative, the customer may identify a financial media service provider to the merchant and allow the merchant to communicate directly with the financial media service provider to facilitate authorization of the transaction. Where the financial institution comprises a financial media service provider, the customer also allows the financial media service provider to transmit the data (including the account number corresponding to the customer's financial media) and the amount due to a bank corresponding to the financial media to facilitate authorization of the transaction. However, the customer does not allow the financial institution to provide the merchant with the account number corresponding to the customer's financial media.

In practice, and as known by those skilled in the art, the function of the financial institution identified in box 208 is often implemented among several financial institutions. Often, a merchant clearing house will actually receive the customer data from the swiped/read financial media, as well as the data showing the amount of the transaction and the merchant. The merchant clearing house may then pass such data to a media holder bank so that the customer's credit line can be checked. An acquiring bank may then acquire and fund the transaction, including paying the merchant's bank (or the merchant directly) a sum corresponding to the transaction amount. Those skilled in the art will thus understand that the present invention may be practiced with a single financial institution or with multiple financial institutions—so long as the basic financial functions of authorizing and appropriately paying transactions without disclosing the customer's media number or account number to the merchant are accomplished.

Box 204 shows a simplified circuit, typically an online enabled device (hereinafter “OED”), for accomplishing the same transaction without the bulk or expense of the complicated circuits found in a personal computer. The OED may be a PDA, notebook computer, laptop computer, mobile telephone or like circuitry. Box 204 includes such an OED which can be coupled to the internet for communication over the internet. The OED contains sufficient human input devices such as a mouse, keyboard, button, switch and/or touch-screen or the like, to allow for surfing the internet and making purchases.

When the customer wishes to select a good or service from a merchant, the customer uses the OED to communicate with the merchant over the internet as shown by dashed line 205 to make the selection. The merchant communicates back to indicate an amount due for the selected good or service. Alternatively, the merchant's website may communicate the amount due by simply displaying prices associated with various goods and services available for selection.

When the customer wishes to make a payment over the internet to a merchant shown in box 212, the customer swipes the card through the magnetic card reader, reads the bar code with the bar code reader or otherwise reads the media with the corresponding media reader. Such reading of the data shows that the customer has physical possession of the financial media in box 200 and does not simply know the account number corresponding to such financial media. The OED is programmed to receive the data, including the account number data, from the magnetic card reader, bar code reader or media reader. The OED then passes that account data (which identifies the customer responsible for the account) as well as the amount of the transaction and the identity of the merchant over the internet in box 206 to the financial institution 208 responsible for the financial media in box 200. This data transmission shown by box 206 is preferably a secure, encrypted data transmission using security techniques known to those skilled in the art. The transaction then proceeds from there as described above.

In practice, the customer preferably purchases, leases or otherwise personally possesses (e.g. personally controls a device provided by an employer) the media reader. Such ownership and/or control provides greater security. The reader may be located in the customer's home, office or personal space.

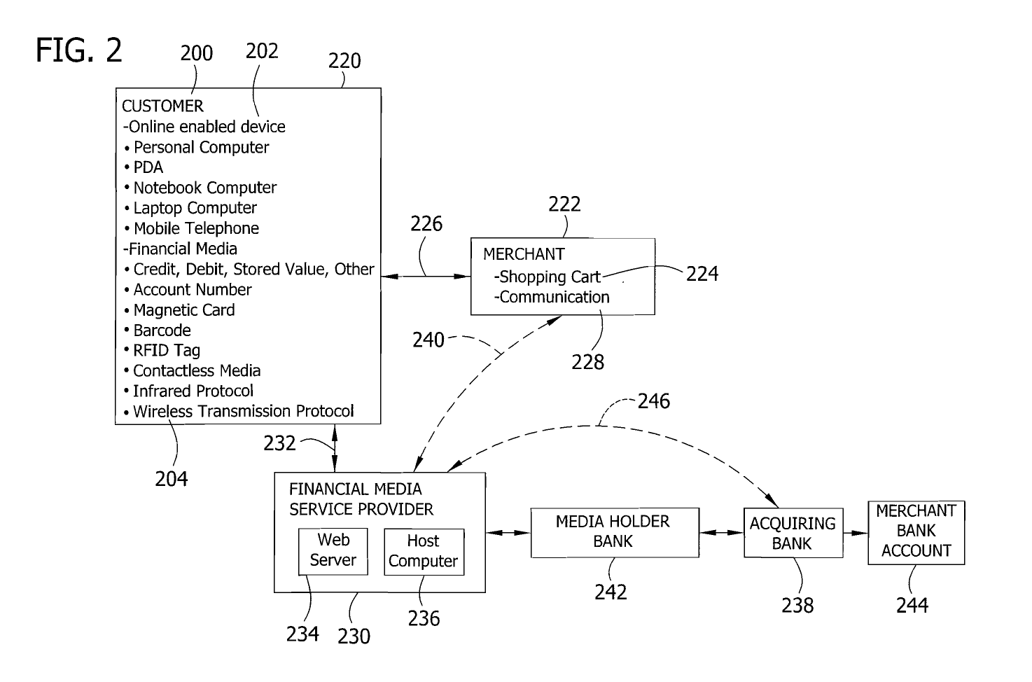

FIG. 2 shows another example of hardware in box 220 for enabling the customer to make a secure payment for a purchase from a third party using a financial media through an internet connection. As in box 200, the financial media can be a conventional credit card, debit card, stored value or other card having a magnetic strip on the back. The financial media can also have a bar code (such as the commonly found one, two and/or three dimensional bar codes commonly found on financial cards). Such media typically have a card number identifying the customer's account against which the purchase will be charged. Alternatively, the financial media in customer box 220 may be a radio frequency identification tag (“RFID tag”) or any of the known contactless financial media which can be read quickly without physical contact between the media and the reader. Examples of such contactless media include the quick pay media where the media may be affixed to a key chain for easy access and is read by simply waving the media past the reader.

The customer 200 can shop at any merchant via website 222 and select goods or services for purchase in a shopping cart 224 through conventional internet shopping software using a conventional connection over the internet 226. When the customer is ready to purchase the selected goods or services, the website 222 communicates the amount due over the internet 226. Such communication can take the form of an invoice 228 transmitted to the customer which identifies the merchant and the amount due. Alternatively, the merchant's website may communicate the amount due by simply displaying prices associated with various goods and services available for selection.

The customer's OED 202 receives the communication and prompts the customer to swipe a financial card through the magnetic card reader, or read the bar code or media with the appropriate reader. Upon such reading, the OED 202 is programmed to encrypt the financial media data and the merchant identifying data and transmit them in encrypted form to a financial media service provider 230 over an internet connection 232. As shown in box 220, the OED can take the form of a personal computer, PDA, notebook computer, mobile telephone or other such device.

The financial media service provider includes a web server 234 for receiving the encrypted data and passing it to a host computer 236. Host computer 236 decrypts the data. Host computer 236 includes a memory for storing information for identifying an acquiring bank 238 for each merchant and/or merchant website 222. If no acquiring bank 238 is identified for a merchant, then the financial media service provider 230 sends a message to the customer 200 seeking such information. The customer can provide the information, if known, or obtain it from the merchant website 222. Alternatively, the financial media service provider 230 can communicate directly with the website 222 over an internet connection 240 to obtain the acquiring bank identification information.

Host computer 236 also communicates with a media holder bank 242 corresponding to the customer's financial media. The host computer 236 thereby determines from the media holder bank 242 whether the customer has a valid account and sufficient funds and/or credit to cover the amount of the purchase. If so, the media holder bank 242 approves the transaction. Otherwise, the transaction is declined.

Once approved, the amount of the purchase is charged against the customer's account in media holder bank 242 which corresponds to the financial media. The merchant is also notified of the approval—preferably by having the media holder bank 242, the acquiring bank 238, and/or the financial media service provider 230 transmit an authorization number for the approved transaction to the merchant 222 through an internet connection. The media holder bank 242 then provides funds to the acquiring bank 238 in the amount of the purchase less an interchange fee. The acquiring bank 238 has an account 242 for the merchant 222 which is credited in the amount of the purchase less a discount percentage. In this manner, the merchant receives an authorization number from a financial institution via the internet in lieu of receiving the financial media number from the retail customer in order to validate the customer's purchase of the selected goods or services.

FIG. 2 also shows a communication line 246, such as the internet or a telephone line, for situations where the financial media service provider or one of the other financial institutions wishes to communicate directly with the acquiring bank 238.

The apparatus and method shown in FIG. 2 thus provide the customer with a magnetic card reader and/or bar code reader and/or media reader for making purchases over the internet using the financial media, but without ever providing the financial media number or other personal financial information to the merchant 222. Thus, whether the merchant website is secure or not secure, the customer's financial data will never be misused by the merchant or subject to compromise by a hacker. Further, the customer will have proven possession of the financial media for every transaction which inhibits unscrupulous individuals from improperly using third party financial media information to make their own improper purchases.

The particular communication paths shown in FIG. 2 can be accomplished in various ways within the scope of the invention. For example, after the customer initiates the purchase process, the merchant website 222 might send a communication to the customer over internet connection 226, as above, but might also provide the financial media service provider 230 with the identity of the merchant's acquiring bank 238 and, perhaps, the identity of the merchant's bank account 244. By communicating this information directly with the financial media service provider 230 and not the customer, the merchant 222 has its own added degree of security.

Other communication paths shown in FIG. 2 can also be accomplished within the scope of the invention, so long as the customer is provided with hardware for reading the data stored on the magnetic stripe or bar code of the financial media (or a reader for other financial media) and then transmitting the data for ultimate receipt by the media holder bank 242 for authorization of the transaction without the merchant/merchant website 222 ever having received the customer's financial account number data.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

What is claimed is:

1. An apparatus for enabling a retail customer to make a payment for a purchase from a third party using a financial card through an internet connection, the purchase to be charged against an account held by the retail customer with a financial institution, the apparatus comprising:
a magnetic card reader located in the retail customer's home, office or personal space for enabling the retail customer to swipe the financial card through the magnetic card reader, wherein the magnetic card reader is adapted to read customer information upon the occurrence of the card being swiped;
a circuit coupled to the magnetic card reader and the internet connection for transmitting the following to the financial institution over the internet: the customer information, data corresponding to the third party and a monetary amount corresponding to the purchase;
whereby the monetary amount corresponding to the purchase may be charged against the account.

2. The apparatus of claim 1 wherein the circuit comprises a personal computer and wherein the magnetic card reader is physically attached to a keyboard, chassis or display of the personal computer.

3. The apparatus of claim 1 wherein the financial card bears a card number identifying the account held by the retail customer with the financial institution, wherein the financial institution is authorized to transmit an authorization number to the third party to validate the purchase, and wherein the financial institution is not authorized to transmit the card number to the third party.

4. The apparatus of claim 1 wherein the circuit comprises a laptop computer, a personal digital assistant, a notebook computer, or a mobile telephone.

5. A method for a customer to pay for a transaction over an internet connection comprising:
selecting a good or service from a merchant through the internet connection;
receiving a communication from the merchant indicating an amount due for the transaction;
reading data from a financial media with a reader, the data including an account number corresponding to the financial media;
transmitting the data and the amount due to a financial institution corresponding to the financial media;
allowing the financial institution to provide an authorization number to the merchant indicating that the transaction has been approved;
whereby the merchant does not obtain access to the account number.

6. The method of claim 5 wherein the financial media comprises a financial card and where the reading step comprises reading data from the financial card with a card reader, the data including an account number corresponding to the financial card.

7. The method of claim 6 wherein the reading step comprises swiping the financial card through a magnetic card reader.

8. The method of claim 6 wherein the reading step comprises reading a bar code printed on the financial card with a bar code reader.

9. The method of claim 5 further comprising the step of purchasing, leasing or otherwise possessing the reader; and thereafter performing the reading step with said reader.

10. The method of claim 5 wherein the transmitting step further comprises the step of transmitting a merchant identifier to the financial institution.

11. The method of claim 5 wherein the financial institution comprises a financial media service provider and wherein the method further comprises the step of:
allowing the financial media service provider to transmit the data and the amount due to a bank corresponding to the financial media to facilitate authorization of the transaction.

12. The method of claim 5 further comprising the steps of:
identifying a financial media service provider to the merchant; and
allowing the merchant to communicate directly with the financial media service provider to facilitate authorization of the transaction.

13. An apparatus for making a payment to a merchant for a transaction over an internet connection comprising:
an online enabled device connected to the internet for receiving a communication from the merchant indicating an amount due for the transaction;
a reader for reading data from a financial media, the data including an account number corresponding to the financial media;
wherein the online enabled device transmits the data and the amount due to a financial institution corresponding to the financial media and allows the financial institution to provide an authorization number to the merchant indicating that the transaction has been approved;
whereby the merchant does not obtain access to the account number data.

14. The apparatus of claim 13 wherein the reader comprises a magnetic card reader, a bar code reader, or a radio frequency identification tag reader.

15. The apparatus of claim 13 wherein the reader comprises a reader that is owned, leased or otherwise possessed by a person making the payment for the transaction.

16. The apparatus of claim 13 wherein the reader reads the data from the financial media via a radio frequency identification protocol, an infrared protocol or another wireless transmission protocol.

17. The apparatus of claim 13 wherein the online enabled device transmits a merchant identifier to the financial institution.

18. The apparatus of claim 13 wherein the online enabled device is programmed to identify a financial media service provider to the merchant, and to provide a code to the merchant to allow the merchant to communicate directly with the financial media service provider to facilitate authorization of the transaction.

19. The apparatus of claim 13 wherein the online enabled device comprises a personal computer, a laptop computer, a personal digital assistant, a notebook computer, or a mobile telephone.

20. The apparatus of claim 13 wherein the financial media comprises contactless media for storing data which can be read without any physical contact between the contactless media and the reader.
